(19) United States
(12) Patent Application Publication
(10) Pub. No.: US 2003/0182371 A1
(43) Pub. Date: Sep. 25, 2003

(54) Asynchronous, leader-facilitated, collaborative networked communication system

(76) Inventor: William C. Worthen, Minnetonka, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/272,445

(22) Filed: Oct. 15, 2002

Related U.S. Application Data
(60) Provisional application No. 60/329,630, filed on Oct. 15, 2001.

(51) Int. Cl. G06F 15/16

(52) U.S. Cl. 709/204

(57) ABSTRACT

An asynchronous, leader facilitated, collaborative networked communications system comprises a secure website to which members of a community can connect using an Internet browser software program. Collaborative communication is begun by posting a member-initiated message to the website for a leader to review and determine whether at least a portion of the message should be broadcast to at least a portion of the membership. Broadcast of the message is preferably accomplished by notifying selected members about the message, such that the message is viewed by the selected members and a communications session among the selected members, member posting the message, and leader, via the secured website, is authorized.

### RELATED APPLICATION

This application claims the benefit of U.S. Provisional Application No. 60/329,630, filed on Oct. 15, 2001, hereby incorporated herein in its entirety by reference. This application is also related to the co-pending patent application entitled Asynchronous, Networked Publication and Collaborative Communication System, filed on Oct. 15, 2002 and assigned to the assignee of the present invention.

### Compact Disc

A compact disc containing codes and information describing a preferred embodiment of the present invention is submitted herewith and is hereby incorporated by reference. The compact disc contains the following files and/or programs:

| | Size in | Date of |
|---|---|---|
| Title | Bytes | Creation |
| UnityworksSource.txt | 15,977 | Oct. 14, 2002 |
| D:\UWSource | | |
| UnityWorks_Database.sql | 205,915 | Oct. 14, 2002 |
| UnityworksSource.txt | 15,977 | Oct. 14, 2002 |
| D:\UWSource\Components | 0 bytes | |
| D:\UWSource\Components\Business | | |
| BroadcastList.cls | 6,410 | Sep. 19, 2002 |
| BroadcastLists.cls | 3,033 | Sep. 19, 2002 |
| CContent.cls | 19,041 | Oct. 1, 2002 |
| CContentList.cls | 11,369 | May 23, 2002 |
| CContentPool.cls | 22,470 | Sep. 20, 2002 |
| CMRA.cls | 21,546 | Sep. 19, 2002 |
| CNotes.cls | 3,817 | Sep. 19, 2002 |
| Contact.cls | 11,003 | Sep. 19, 2002 |
| Context.bas | 5,246 | Sep. 20, 2002 |
| CSession.cls | 3,688 | Oct. 1, 2002 |
| CSlideSet.cls | 34,739 | Oct. 8, 2002 |
| CSlideSetList.cls | 12,776 | Sep. 19, 2002 |
| CVisitor.cls | 6,673 | Jan. 15, 2002 |
| DB.bas | 6,568 | Sep. 19, 2002 |
| Encryption.bas | 2,644 | Dec. 7, 2001 |
| ErrorCodes.bas | 22,851 | Jul. 16, 2002 |
| Event.cls | 26,385 | Oct. 1, 2002 |
| Events.cls | 4,822 | Sep. 19, 2002 |
| FileSystem.bas | 2,085 | Aug. 1, 2002 |
| Format.bas | 10,640 | Sep. 19, 2002 |
| Group1.vbg | 166 | Dec. 21, 2001 |
| IContent.cls | 1,485 | Apr. 27, 2002 |
| Link.cls | 6,284 | Dec. 20, 2001 |
| Links.cls | 4,376 | Dec. 20, 2001 |
| Location.cls | 15,182 | Sep. 19, 2002 |
| Locations.cls | 3,570 | Sep. 19, 2002 |
| Mapping.bas | 5,963 | Sep. 19, 2002 |
| Member.cls | 25,175 | Oct. 14, 2002 |
| Members.cls | 4,174 | Sep. 19, 2002 |
| Membership.cls | 24,874 | Oct. 14, 2002 |
| Memberships.cls | 5,120 | Sep. 19, 2002 |
| Message.cls | 26,297 | Oct. 1, 2002 |
| Messages.cls | 4,482 | Sep. 19, 2002 |
| mssccprj.scc | 164 | Oct. 11, 2002 |
| Page.cls | 9,010 | Dec. 7, 2001 |
| Pages.cls | 4,179 | Dec. 7, 2001 |
| PublishQueue.cls | 6,801 | Jul. 16, 2002 |
| Reminder.cls | 9,078 | Sep. 19, 2002 |
| Reminders.cls | 4,853 | Sep. 19, 2002 |
| SessionState.cls | 902 | Jun. 12, 2002 |
| Team.cls | 40,265 | Sep. 20, 2002 |
| Teams.cls | 4,105 | Sep. 19, 2002 |
| Unity_Business.dll | 372,736 | Oct. 11, 2002 |
| Unity_Business.vbp | 3,384 | Oct. 11, 2002 |
| Validation.bas | 4,564 | Sep. 19, 2002 |
| D:\UWSource\Components\DB | | |
| CCache.cls | 6,166 | Jan. 31, 2002 |
| CDB_XML.cls | 25,336 | Sep. 26, 2002 |
| CDBIO.cls | 67,009 | Oct. 11, 2002 |
| Context.bas | 5,246 | Sep. 20, 2002 |
| DB.bas | 6,568 | Sep. 19, 2002 |
| Format.bas | 10,640 | Sep. 19, 2002 |
| Group1.vbg | 160 | Jan. 16, 2002 |
| mssccprj.scc | 152 | Oct. 11, 2002 |
| Project1.vbp | 698 | Dec. 11, 2001 |
| Project1.vbw | 28 | Dec. 11, 2001 |
| Unity_DB.dll | 131,072 | Oct. 11, 2002 |
| Unity_DB.vbp | 1,798 | Oct. 11, 2002 |
| D:\UWSource\Components\Strings | | |
| CErrorMessages.cls | 2,804 | Dec. 7, 2001 |
| Context.bas | 5,246 | Sep. 20, 2002 |
| ErrorCodes.bas | 22,851 | Jul. 16, 2002 |
| Group1.vbg | 149 | Dec. 20, 2001 |
| mssccprj.scc | 159 | Oct. 11, 2002 |
| Strings_English.bas | 20,920 | Sep. 19, 2002 |
| Unity_Strings.dll | 36,864 | Oct. 3, 2002 |
| Unity_Strings.vbp | 1,187 | Oct. 3, 2002 |
| D:\UWSource\Components\Utils | | |
| CBase29.cls | 1,748 | Dec. 19, 2001 |
| CBase34.cls | 1,277 | Dec. 7, 2001 |
| CBase36.cls | 1,277 | Dec. 7, 2001 |
| CBase62.cls | 1,301 | Dec. 7, 2001 |
| CCollection.cls | 2,202 | Dec. 7, 2001 |
| CEncrypt.cls | 9,355 | Dec. 7, 2001 |
| CErrorMessages.cls | 2,804 | Jan. 21, 2002 |
| Context.bas | 5,246 | Sep. 20, 2002 |
| CRegistryTool.cls | 10,819 | Dec. 7, 2001 |
| CStringBuilder.cls | 13,753 | Mar. 18, 2002 |
| CTimer.cls | 1,473 | Dec. 7, 2001 |
| ErrorCodes.bas | 22,860 | Jan. 21, 2002 |
| mssccprj.scc | 276 | Oct. 11, 2002 |
| Strings_English.bas | 20,608 | Jan. 21, 2002 |
| Unity_Strings.vbp | 1,324 | Apr. 8, 2002 |
| Unity_Strings.vbw | 102 | Mar. 6, 2002 |
| Unity_Utils.dll | 45,056 | Oct. 9, 2002 |
| Unity_Utils.vbp | 1,503 | Oct. 9, 2002 |
| D:\UWSource\Components\ | | |
| Web2002_03_11 | | |
| CSlideViewer.cls | 74,409 | Mar. 11, 2002 |
| Broadcast.cls | 27,572 | Oct. 8, 2002 |
| BroadcastListDetail.cls | 23,841 | Oct. 4, 2002 |
| CallStack.bas | 2,616 | Apr. 5, 2002 |
| CallState.bas | 52 | Jun. 12, 2002 |
| CareCast.cls | 6,788 | Jul. 16, 2002 |
| CCallState.cls | 26,962 | Oct. 8, 2002 |
| CCustomerService.cls | 9,228 | Oct. 11, 2002 |
| CImage.cls | 6,617 | Jan. 7, 2002 |
| CListView.cls | 51,608 | Oct. 11, 2002 |
| CMRAForm.cls | 35,140 | Oct. 4, 2002 |
| CNotes.cls | 3,405 | Mar. 28, 2002 |
| Configuration.cls | 33,007 | Oct. 4, 2002 |
| ContentSubmission.cls | 12,101 | Jan. 3, 2002 |
| Context.bas | 5,246 | Sep. 20, 2002 |
| CSlideViewer.cls | 146,574 | Oct. 11, 2002 |
| CView.cls | 29,319 | Oct. 8, 2002 |
| CViewContainer.cls | 18,333 | Oct. 4, 2002 |
| CViews.cls | 1,623 | Sep. 19, 2002 |
| EditorTool.cls | 36,059 | Oct. 8, 2002 |
| Email.bas | 24,467 | Sep. 19, 2002 |
| Encryption.bas | 2,644 | Dec. 7, 2001 |
| ErrorCodes.bas | 22,851 | Jul. 16, 2002 |
| EventCalendar.cls | 24,302 | Oct. 4, 2002 |
| EventDetail.cls | 31,286 | Oct. 4, 2002 |
| FileSystem.bas | 2,085 | Aug. 1, 2002 |
| Folder.cls | 25,161 | Sep. 19, 2002 |
| Format.bas | 10,640 | Sep. 19, 2002 |
| HTMLFunctions.bas | 61,967 | Oct. 9, 2002 |
| InvitationTool.cls | 11,037 | Sep. 26, 2002 |
| IWebComponent.cls | 1,138 | Feb. 21, 2002 |
| KO_Ministry.cls | 4,199 | May 10, 2002 |
| KO_Portfolio.cls | 7,083 | Aug. 1, 2002 |
| LocationDetail.cls | 382 | Dec. 19, 2001 |
| MasterView.cls | 21,595 | Sep. 19, 2002 |
| MembershipDetail.cls | 55,892 | Oct. 14, 2002 |
| MessageBoard.cls | 53,634 | Oct. 4, 2002 |
| MessageDetail.cls | 93,667 | Oct. 14, 2002 |
| mssccprj.scc | 154 | Oct. 11, 2002 |
| Notification.cls | 378 | Dec. 19, 2001 |
| Page.cls | 19,161 | Oct. 11, 2002 |
| PasswordRecovery.cls | 11,211 | Sep. 26, 2002 |
| Publish.cls | 19,624 | Oct. 4, 2002 |
| Publisher.cls | 7,916 | Jun. 18, 2002 |
| Roster.cls | 19,735 | Sep. 26, 2002 |
| Rotator.cls | 3,482 | Dec. 19, 2001 |
| Search.cls | 11,571 | Sep. 19, 2002 |
| Security.cls | 8,415 | Aug. 1, 2002 |
| SubmissionDetail.cls | 5,730 | Dec. 19, 2001 |
| TeamDetail.cls | 25,358 | Sep. 26, 2002 |
| TeamHeader.cls | 16,414 | Sep. 19, 2002 |
| TemplateSelector.cls | 11,073 | Oct. 04, 2002 |
| Unity_Web.dll | 962,560 | Oct. 11, 2002 |
| Unity_Web.vbp | 4,704 | Oct. 14, 2002 |
| UnityConstants.bas | 508 | Feb. 21, 2002 |
| UnityWorksTemplate.bas | 478 | Dec. 19, 2001 |
| UserHTML.cls | 9,312 | Aug. 1, 2002 |
| VerticalNav.cls | 16,732 | Sep. 26, 2002 |
| Video.cls | 7,119 | May 10, 2002 |
| WebComponents.cls | 3,580 | Dec. 19, 2001 |
| WebModuleWrapper.cls | 9,714 | Sep. 26, 2002 |
| D:\UWSource\Website | | |
| _Inc_Common.asp | 5,663 | Aug. 7, 2002 |
| _Inc_FlowControl.asp | 431 | Aug. 2, 2002 |
| about.asp | 383 | Aug. 2, 2002 |
| commonFunctions.asp | 1,028 | Aug. 2, 2002 |
| contact.asp | 457 | Aug. 2, 2002 |
| default.asp | 15,973 | Oct. 11, 2002 |
| default.css | 12,496 | Aug. 26, 2002 |
| desktop.ini | 114 | Feb. 25, 2000 |
| empty.htm | 279 | Aug. 2, 2002 |
| help.htm | 575 | Aug. 2, 2002 |
| intro.asp | 1,262 | Aug. 2, 2002 |
| jesus.asp | 1,682 | Aug. 2, 2002 |
| pageHeaders.asp | 450 | Aug. 2, 2002 |
| PicView.asp | 560 | Aug. 2, 2002 |
| press.asp | 353 | Aug. 2, 2002 |
| privacy.asp | 381 | Aug. 2, 2002 |
| services.asp | 384 | Aug. 2, 2002 |
| team_legal.htm | 3,704 | Aug. 2, 2002 |
| tempoffline.asp | 343 | Aug. 2, 2002 |
| terms.asp | 8,253 | Oct. 8, 2002 |
| visitorAdd.asp | 5,044 | Aug. 2, 2002 |
| visitorAdopt.asp | 3,473 | Aug. 2, 2002 |
| visitorList.asp | 2,880 | Aug. 2, 2002 |
| vssver.scc | 80 | Aug. 26, 2002 |
| WebListView.asp | 8,956 | Oct. 8, 2002 |
| WebListView.htm | 861 | Oct. 7, 2002 |
| WebPreview.asp | 8,281 | Aug. 19, 2002 |
| WebPreview.htm | 638 | Aug. 27, 2002 |
| welcome.htm | 985 | Aug. 2, 2002 |
| D:\UWSource\Website\_private | | |
| charity.xml | 2,174 | Aug. 20, 2002 |
| community.xml | 1,515 | Oct. 8, 2002 |
| config_Ministry.xml | 2,110 | Jul. 8, 2002 |
| config_ministry_newsOnly.xml | 1,202 | Oct. 8, 2002 |
| config_WorkGroup.xml | 2,817 | Jul. 8, 2002 |
| contentEditor.xml | 1,463 | Oct. 8, 2002 |
| CustServ.xml | 3,312 | Sep. 17, 2002 |
| propertyManager.xml | 892 | Jul. 8, 2002 |
| sales.xml | 1,200 | Jul. 8, 2002 |
| SeniorPastor.xml | 2,204 | Oct. 8, 2002 |
| support.xml | 1,253 | Oct. 8, 2002 |
| unityTeam.xml | 2,562 | Jul. 31, 2002 |
| workGroup.xml | 6,248 | Sep. 10, 2002 |
| D:\UWSource\Website\CustServ | | |
| _Inc_MRACommon.asp | 1,367 | Jul. 10, 2002 |
| CSMain.asp | 1,246 | Jul. 10, 2002 |
| MRACheckIn.asp | 2,087 | Jul. 10, 2002 |
| MRADetail.asp | 5,698 | Sep. 10, 2002 |
| MRAInstall.asp | 2,889 | Sep. 10, 2002 |
| MRAQueue.asp | 4,068 | Sep. 10, 2002 |
| D:\UWSource\Website\images | | |
| ball_sage.gif | 113 | Jun. 11, 2002 |
| bold.gif | 82 | Oct. 8, 2002 |
| btnAction_01.gif | 718 | Aug. 22, 2002 |
| btnAction_02.gif | 173 | Aug. 22, 2002 |
| btnAction_03.gif | 115 | Aug. 22, 2002 |
| btnAction_04.gif | 1,675 | Aug. 22, 2002 |
| btnAction_05.gif | 159 | Aug. 22, 2002 |
| btnActionHi_01.gif | 700 | Aug. 28, 2002 |
| btnActionHi_02.gif | 147 | Aug. 28, 2002 |
| btnActionHi_03.gif | 114 | Aug. 28, 2002 |
| btnActionHi_04.gif | 1,766 | Aug. 28, 2002 |
| btnActionHi_05.gif | 143 | Aug. 28, 2002 |
| bulletList.gif | 85 | Oct. 8, 2002 |
| cannon_sm.gif | 1,279 | Oct. 8, 2002 |
| cannon_x-sm.gif | 356 | Aug. 28, 2002 |
| CareCast_logo.gif | 5,029 | Oct. 8, 2002 |
| center.gif | 73 | Oct. 8, 2002 |
| cleardot.gif | 42 | Oct. 8, 2002 |
| ConTemp1.bmp | 36,214 | Apr. 29, 2002 |
| ConTemp1.JPG | 4,344 | Apr. 29, 2002 |
| ConTemp2.jpg | 36,214 | Apr. 29, 2002 |
| ConTemp3.jpg | 6,324 | Apr. 29, 2002 |
| ConTemp4.JPG | 3,238 | Apr. 29, 2002 |
| CornerBeigeLeft.gif | 864 | Oct. 8, 2002 |
| CornerBeigeRight.gif | 864 | Oct. 8, 2002 |
| CornerWhiteLeft.gif | 866 | Oct. 8, 2002 |
| CornerWhiteLeftOn.gif | 865 | Oct. 8, 2002 |
| CornerWhiteRight.gif | 864 | Oct. 8, 2002 |
| CornerWhiteRightOn.gif | 864 | Oct. 8, 2002 |
| edit.gif | 866 | Oct. 8, 2002 |
| filmstrip_btm.gif | 899 | Oct. 8, 2002 |
| filmstrip_top.gif | 879 | Oct. 8, 2002 |
| fraCaption_01.gif | 947 | Sep. 6, 2002 |
| fraCaption_02.gif | 728 | Sep. 6, 2002 |
| fraCaption_03.gif | 949 | Sep. 6, 2002 |
| fraCaption_04.gif | 134 | Sep. 6, 2002 |
| fraCaption_05.gif | 294 | Sep. 6, 2002 |
| fraCaption_06.gif | 135 | Sep. 6, 2002 |
| fraCaption_07.gif | 934 | Sep. 6, 2002 |
| fraCaption_08.gif | 723 | Sep. 6, 2002 |
| fraCaption_09.gif | 981 | Sep. 6, 2002 |
| genFrame_01.gif | 296 | Oct. 8, 2002 |
| genFrame_02.gif | 187 | Oct. 8, 2002 |
| genFrame_03.gif | 307 | Oct. 8, 2002 |
| genFrame_04.gif | 253 | Oct. 8, 2002 |
| genFrame_05.gif | 128 | Oct. 8, 2002 |
| genFrame_06.gif | 249 | Oct. 8, 2002 |
| genFrame_07.gif | 212 | Oct. 8, 2002 |
| genFrame_08.gif | 211 | Oct. 8, 2002 |
| genFrame_09.gif | 264 | Oct. 8, 2002 |
| genFrame_10.gif | 264 | Oct. 8, 2002 |
| genFrame_11.gif | 299 | Oct. 8, 2002 |
| genFrame_12.gif | 187 | Oct. 8, 2002 |
| genFrame_13.gif | 294 | Oct. 8, 2002 |
| glow.gif | 2,279 | Oct. 8, 2002 |
| header_bg.jpg | 503 | Apr. 8, 2002 |
| hex0.gif | 85,109 | Oct. 8, 2002 |
| iconHelp.gif | 1,351 | Oct. 8, 2002 |
| img1.jpg | 8,709 | Oct. 8, 2002 |
| indent.gif | 93 | Oct. 8, 2002 |
| italic.gif | 83 | Oct. 8, 2002 |
| KingdomOil_logo.gif | 6,360 | Oct. 8, 2002 |
| KingdomOil_logo.jpg | 3,895 | Oct. 8, 2002 |
| kit.jpg | 7,442 | Oct. 8, 2002 |
| left.gif | 73 | Oct. 8, 2002 |
| magnify.gif | 325 | Oct. 8, 2002 |
| minus.gif | 336 | Oct. 8, 2002 |
| minus2.gif | 861 | Oct. 8, 2002 |
| NextPage.gif | 1,008 | Oct. 8, 2002 |
| node.gif | 344 | Oct. 8, 2002 |
| node2.gif | 838 | Oct. 8, 2002 |
| numberList.gif | 86 | Oct. 8, 2002 |
| outdent.gif | 93 | Oct. 8, 2002 |
| page_01.jpg | 434 | Oct. 8, 2002 |
| page_02.jpg | 412 | Oct. 8, 2002 |
| page_03.jpg | 1,053 | Oct. 8, 2002 |
| page_04.jpg | 429 | Oct. 8, 2002 |
| page_05.jpg | 419 | Oct. 8, 2002 |
| page_06.jpg | 2,231 | Oct. 8, 2002 |
| page_07.jpg | 424 | Oct. 8, 2002 |
| page_08.jpg | 503 | Oct. 8, 2002 |
| page_09.jpg | 489 | Oct. 8, 2002 |
| page_10.jpg | 531 | Oct. 8, 2002 |
| page_11.jpg | 2,077 | Oct. 8, 2002 |
| page_12.jpg | 455 | Oct. 8, 2002 |
| page_13.jpg | 494 | Oct. 8, 2002 |
| page_14.jpg | 4,863 | Oct. 8, 2002 |
| page_15.jpg | 618 | Oct. 8, 2002 |
| page_16.jpg | 570 | Oct. 8, 2002 |
| page_17.jpg | 1,889 | Oct. 8, 2002 |
| page_18.jpg | 1,651 | Oct. 8, 2002 |
| page_19.jpg | 582 | Oct. 8, 2002 |
| page_20.jpg | 587 | Oct. 8, 2002 |
| page_21.jpg | 561 | Oct. 8, 2002 |
| page_22.jpg | 633 | Oct. 8, 2002 |
| page_23.jpg | 2,861 | Oct. 8, 2002 |
| page_24.jpg | 528 | Oct. 8, 2002 |
| page_25.gif | 223 | Oct. 8, 2002 |
| page_25.jpg | 426 | Oct. 8, 2002 |
| photoframe.gif | 2,143 | Oct. 8, 2002 |
| photoframe-1x1.gif | 78 | Oct. 8, 2002 |
| photoframe-1x2.gif | 668 | Oct. 8, 2002 |
| photoframe-2x1.gif | 101 | Oct. 8, 2002 |
| photoframe-3x1.gif | 564 | Oct. 8, 2002 |
| plus.gif | 206 | Oct. 8, 2002 |
| plus2.gif | 866 | Oct. 8, 2002 |
| poweredby_unityworks1.gif | 2,470 | Oct. 8, 2002 |
| PreviousPage.gif | 1,005 | Oct. 8, 2002 |
| publishIcon.gif | 382 | Aug. 28, 2002 |
| publishIcon2.gif | 377 | Aug. 28, 2002 |
| right.gif | 73 | Oct. 8, 2002 |
| rt_arrow.gif | 864 | Oct. 8, 2002 |
| Shortcut to images.Ink | 598 | Mar. 18, 2002 |
| shortViewer_30.gif | 1,169 | Oct. 8, 2002 |
| shortViewer_30.jpg | 873 | Apr. 8, 2002 |
| shortViewer_31.gif | 1,468 | Oct. 8, 2002 |
| shortViewer_31.jpg | 796 | Apr. 8, 2002 |
| shortViewer_32.jpg | 813 | Oct. 8, 2002 |
| shortViewer_33.gif | 1,619 | Oct. 8, 2002 |
| shortViewer_33.jpg | 836 | Apr. 8, 2002 |
| shortViewer_34.gif | 2,844 | Oct. 8, 2002 |
| shortViewer_34.jpg | 1,428 | Apr. 8, 2002 |
| spacer.gif | 43 | Oct. 8, 2002 |
| tab_off.gif | 1,019 | Oct. 8, 2002 |
| tab_on.gif | 2,569 | Oct. 8, 2002 |
| thinFrame_01.gif | 279 | Aug. 23, 2002 |
| thinFrame_02.gif | 196 | Aug. 23, 2002 |
| thinFrame_03.gif | 279 | Aug. 23, 2002 |
| thinFrame_04.gif | 96 | Aug. 23, 2002 |
| thinFrame_05.gif | 1,206 | Aug. 23, 2002 |
| thinFrame_06.gif | 151 | Aug. 23, 2002 |
| thinFrame_07.gif | 122 | Aug. 23, 2002 |
| thinFrame_08.gif | 146 | Aug. 23, 2002 |
| thinFrame_09.gif | 146 | Aug. 23, 2002 |
| thinFrame_10.gif | 150 | Aug. 23, 2002 |
| thinFrame_11.gif | 278 | Aug. 23, 2002 |
| thinFrame_12.gif | 196 | Aug. 23, 2002 |
| thinFrame_13.gif | 278 | Aug. 23, 2002 |
| under.gif | 90 | Oct. 8, 2002 |
| underline.gif | 827 | Oct. 8, 2002 |
| UnityWorks_BG.gif | 31,786 | Oct. 8, 2002 |
| UnityWorks_logo.gif | 5,961 | Oct. 8, 2002 |
| welcome_01.jpg | 1,591 | Oct. 1, 2002 |
| welcome_02.jpg | 8,909 | Oct. 1, 2002 |
| welcome_03.jpg | 10,680 | Oct. 1, 2002 |
| welcome_04.gif | 2,618 | Oct. 1, 2002 |
| welcome_05.jpg | 4,609 | Oct. 1, 2002 |
| welcome_06.jpg | 2,380 | Oct. 1, 2002 |
| welcome_07.jpg | 6,059 | Oct. 1, 2002 |
| welcome_08.jpg | 8,503 | Oct. 1, 2002 |
| welcome_09.jpg | 959 | Oct. 1, 2002 |
| welcome_10.jpg | 3,977 | Oct. 1, 2002 |
| welcome_11.jpg | 4,513 | Oct. 1, 2002 |
| welcome_11-over.jpg | 4,179 | Oct. 1, 2002 |
| welcome_12.jpg | 935 | Oct. 1, 2002 |
| welcome_13.gif | 3,747 | Oct. 1, 2002 |
| welcome_14.jpg | 1,806 | Oct. 1, 2002 |
| welcome_15.jpg | 787 | Oct. 1, 2002 |
| welcome_16.gif | 3,487 | Oct. 1, 2002 |
| welcome_17.jpg | 584 | Oct. 1, 2002 |
| welcome_18.jpg | 420 | Oct. 1, 2002 |
| welcome_19.gif | 1,463 | Oct. 1, 2002 |
| welcome_20.gif | 2,574 | Oct. 1, 2002 |
| welcome_21.jpg | 473 | Oct. 1, 2002 |
| welcome_22.jpg | 470 | Oct. 1, 2002 |
| workZone.gif | 1,281 | Oct. 8, 2002 |
| workZone_enter.gif | 2,435 | Oct. 8, 2002 |
| workZone_enter2.gif | 2,138 | Oct. 8, 2002 |
| D:\UWSource\Website\images\members | 0 bytes | |
| D:\UWSource\Website\images\ | 0 bytes | |
| messages | | |
| D:\UWSource\Website\images\slides | 0 bytes | |
| D:\UWSource\Website\images\tabs | 0 bytes | |
| D:\UWSource\Website\images\template | 0 bytes | |
| D:\UWSource\Website\jscripts | | |
| contentScript.js | 4,380 | Oct. 8, 2002 |
| contentScript_old.js | 3,808 | Oct. 1, 2002 |
| contentScript2.js | 4,082 | Oct. 8, 2002 |
| vssver.scc | 48 | Oct. 8, 2002 |
| D:\UWSource\Website\messages | | |
| Thumbs.db | 84,480 | Jan. 25, 2002 |
| D:\UWSource\Website\treegen | | |
| genresize.js | 3,984 | Jun. 11, 2002 |
| TgToc.js | 17,186 | Jun. 11, 2002 |
| D:\UWSource\Website\treegen\images | | |
| back.gif | 828 | Jun. 11, 2002 |
| bullets.mic | 147,456 | Jun. 11, 2002 |
| demologo.gif | 3,410 | Jun. 11, 2002 |
| empty.gif | 135 | Jun. 11, 2002 |
| foldercol.gif | 1,021 | Jun. 11, 2002 |
| folderexp.gif | 1,022 | Jun. 11, 2002 |
| img.gif | 35 | Jun. 11, 2002 |
| imgminus.gif | 96 | Jun. 11, 2002 |
| imgplus.gif | 98 | Jun. 11, 2002 |
| item.gif | 926 | Jun. 11, 2002 |
| itemline.jpg | 972 | Jun. 11, 2002 |
| line1.gif | 846 | Jun. 11, 2002 |
| line2.gif | 852 | Jun. 11, 2002 |
| line3.gif | 846 | Jun. 11, 2002 |
| link.gif | 97 | Jun. 11, 2002 |
| minus.gif | 869 | Jun. 11, 2002 |
| minus1.gif | 878 | Jun. 11, 2002 |
| minus2.gif | 880 | Jun. 11, 2002 |
| plus.gif | 873 | Jun. 11, 2002 |
| plus1.gif | 878 | Jun. 11, 2002 |
| plus2.gif | 881 | Jun. 11, 2002 |
| triangle.gif | 1,218 | Jun. 11, 2002 |
| white.gif | 89 | Jun. 11, 2002 |

### FIELD OF THE INVENTION

This invention relates to a process or apparatus for transferring data among a plurality of spatially distributed computers or digital data processing systems via one or more communications media. In particular, this invention relates to a system and method for asynchronous, leader-facilitated, collaborative communication through a secure website via the Internet conducted via email.

### BACKGROUND OF THE INVENTION

During the past fifty years, certain trends in our workforce have been continued with increased concern by many. First, as work skills have become more specialized and knowledge more important to worker performance, the workforce has by necessity become more mobile as workers often move great distances to accept the next job or position. Where once family and close friends were within walking distance, family and friends now are often very spread out geographically. Second, the average number of hours per week that workers are working has increased so that workers often find it more and more difficult to maintain close connections with family and friends. Finally, as technology has been eliminating mundane, routine tasks from the workplace and dramatically decreasing the time required to complete other tasks, workers are working at a faster pace with less time to think about and make good decisions with a high degree of confidence.

In recent years, the health profession has recognized these trends as leading towards higher job related stress and job dissatisfaction, as workers are having more difficulty balancing their job related demands with the demands and needs of their personal lives. In effect, the emotional and spiritual support network that most workers once enjoyed is missing in many present day workers' lives, and often these workers are unaware of this until after an unmanageable personal problem or even a health crisis arises. This loss of community is what some religious groups might call an absence of fellowship. By staying in connection with one another and by coming together for one another when there is a need, a greater sense of security can be nurtured with its resulting health and productivity benefits.

Although the Internet is a tool that allows people to work further apart from one another, it is also a tool that can bring people together when they are apart. The Internet has been an important network resource for people to obtain information that is located at a distance. For example, workers can get company data located at another physical site or send someone an email correspondence. Technology has now advanced far enough so that users can talk to one another and transmit still pictures or video. Moreover, with the ever-increasing prevalence of the Internet, more and more people communicate via this medium.

The vast majority of communications over the Internet take the form of emails sent between individuals. It is well known that emails also can be broadcast from one person to any number of recipients by including all of the necessary addresses in the email. Almost all email programs allow for groups of recipients to be identified by collecting a series of email addresses under a single group name such that the email program automatically includes all of the individual addresses whenever the group name is used in the email address. While email has improved the ability for groups of people to stay in touch with one another, the logistics for organizing and communicating among larger groups is often cumbersome with conventional email programs.

Synchronous collaborative software programs, such as Groupwise™ or Lotus Notes™, have been developed in an effort to improve on the group communication potential afforded by networked computer communications. The problem with such specialized collaborative software programs is that every participant must be running the specialized software program in order to participate in the various group communication and management schemes that are provided by these programs.

Several inventions have developed more specialized communication systems for facilitating communications among group members, such as Ziv-E1, U.S. Pat. No. 5,263,869, Interactive Group Communication System; Tang et al., U.S. Pat. No. 5,793,365, System and Method Providing a Computer User Interface Enabling Access to Distributed Workgroup Members; Kley et al., U.S. Pat. No. 5,862,346, Distributed Group Activity Data Network System and Corresponding Method; Gilliam et al., U.S. Pat. No. 5,878,214, Computer-Based Group Problem Solving Method and System; Sonnenreich et al., U.S. Pat. No. 5,974,446, Internet Based Distance Learning System for Communicating Between Server and Clients Wherein Clients Communicate with Each Other or with Teacher Using Different Communication Techniques Via Common User Interface; and Toomey et al., U.S. Pat. No. 6,119,147, Method and System for Computer-Mediated, Multi-Modal, Asynchronous Meetings in a Virtual Space.

While some of these inventions may overcome the limitations of conventional collaborative software programs that require each group member to be running specialized software, these inventions have generally not been developed to enhance communications in a group that includes one or more leaders who are facilitating or mediating the group interaction. Of these inventions, Kley, et al., Tang et al., and Toomey et al. are not leader-facilitated in that a leader is not designated, who can control who has access to communications and who has control over communications. Ziv-E1 and Sonnenreich et al. are both teaching devices in which the leader or coordinator is a teacher or instructor. As such, both have storage for teaching materials that are to be distributed to students, and sessions, communications regarding a particular subject matter, are determined by this curriculum. There is also a facilitator in Gilliam et al. to create a process plan or agenda for and control the collaborative communication of a problem solving session. Each of these systems, however, provide for top-down motivated communications by the leader or teacher, the synchronization of which is often important.

While a variety of networked communication schemes have been developed in response to the potential of Internet email communications, none of these systems has been particularly adapted to the challenges of group communications over the Internet without specialized software where group communications are member-initiated and are facilitated by a leader, such that the communication system enhances the inherent power of group interactions. It would be advantageous to have a networked communication system in which an individual could initiate a session based on a personal, possibly unplanned, need of that individual, or which encourages bottom-up motivated communication and is designed to allow a leader to filter initial messages to ensure that such initial messages meet certain predetermined criteria for beginning a communication session, without controlling the entire collaboration of the group during the communication session.

### SUMMARY OF THE INVENTION

The present invention is an asynchronous, leader facilitated, collaborative networked communications system that provides a secure website to which members of a community can connect using an Internet browser software program. Collaborative communication is begun by posting a member-initiated message to the website for a leader to passively or actively review and determine whether at least a portion of the message should be viewable by additional members. In one embodiment, members are selectively notified about a message posted on a website after the message has been reviewed by a leader to encourage these members to actively participate in a communication session about the content of that message. In another embodiment, by notifying selected members about the message, the message becomes viewable by the selected members and a communications session among the selected members, the member posting the message, and the leader is authorized and supported via the secured website.

The present invention is a collaborative networked communication system by which individuals or members of a leader facilitated group or team or community communicate via the Internet with one another. The networked communication system is asynchronous, leader filtered, and collaborative in that the system allows members to communicate to one another without being present or communicating at the same time. The system and method require no special software other than web-based browsers for members to connect to the secure website. Preferably, hosts are thin-client/browser-based, although in alternative embodiments hosts may be thick-client to allow the present invention to be implemented by user-installed application programs and/or JAVA applets. In one embodiment, a designated leader or other predetermined facilitator(s) reviews a member-initiated message and may approve its continued posting with or without changes or may delete the message. The leader then notifies selected members that a message of interest is viewable on the website. In another embodiment, the member initiated message is viewable only by the leader until the leader or other predetermined facilitator determines, upon reviewing the member-initiated message, whether to authorize a communication session with respect to the message and which additional members of the group or community may view the initial message and participate. Open collaboration among the selected members, member posting the message, and leader, via the secure website location, is allowed once the selected members are notified about the message.

The present invention allows a group member to personally construct his or her own message while maintaining a high degree of privacy, and reduce or eliminate the need for telephone chains, repetitious Internet instant messaging, and similar methods of group communication, all of which are often time consuming and inconsistent both with respect to the members that should be contacted and the notification that is given. The present nivention is particularly advantageous for non-vocational groups such as athletic teams, church groups and support groups.

The collaborative networked communication system enables collaborative communications among a predetermined group of Internet users without specialized software, whereby each of the members and only these members have access to a secure website location. Each member may post messages on the website location, after which the message is filtered and/or facilitated by one or more leader members to determine whether additional members will be notified via email about the initial message and who among the community of members will be notified. Broadcasting a notification via an email process is preferably accomplished though a single user button referred to as a “cannon blast”. Once the additional members are notified, they can access the website location to view the initial message and any subsequently listed member replies or other related communications, and, if so desired, reply to the initial message or to subsequent messages. Preferably, messages are dynamically sorted by communication session or member-initiated message and chronologically arranged. The leader and additional members are preferably notified by email, which contains a hyperlink to the website location for conveniently viewing the messages.

A preferred embodiment of the system for member-initiated, asynchronous, collaborative communication among a predetermined community of members using the Internet comprises a secure website having at least one website location, wherein the website is operatively connected to the Internet to receive and broadcast communications, wherein a website location is designated for use by the community, and wherein only members have authorized access to the website; a member access for each member to the community's website location, wherein each member access is established via an Internet connection using an Internet browser software program; a community leader to facilitate member use of the community's website location; a member-initiated message posted on the community's website location via a member access, wherein the member-initiated message is viewable only by the leader until the leader allows otherwise, and wherein the leader exercises control over at least one communications aspect with respect to the member-initiated message; and a leader authorized communication session via the community's website location with respect to the member-initiated message, wherein the session begins after the member-initiated message is viewable by another member.

In operation, a preferred embodiment of a method for member-initiated, asynchronous, collaborative communication among a predetermined community of members using the Internet comprises (a) providing a secure website having at least one website location, wherein the website is operatively connected to the Internet to receive and broadcast communications, and wherein a website location is designated for use by the community; (b) selecting a community leader; (c) providing each member with a member access to the community's website location when the member establishes an operative Internet connection with the website and properly identifies his- or herself; (d) posting a member-initiated message on the community's website location via a member access to the community's website location; (e) enabling a previously designated leader to notify selected members that the member-initiated message is viewable on the community's website location, whereby a communication session with respect to the member-initiated message and including only the selectively notified members, member posting the member-initiated message, and leader is authorized via the community's website location.

Alternatively, the present invention can be viewed as a computer program for executing a computer process, the computer program being storage medium readable by a computing system operating as a secure website having at least one website location, wherein the website is operatively connected to the Internet, and wherein a website location is designated for use by a predetermined community of members having a community leader, to receive and broadcast member-initiated, asynchronous, collaborative communications among the members.

### BRIEF DESCRIPTION OF THE DRAWINGS

FIG. 1 is an overview of an asynchronous, leader-facilitated, collaborative, networked communication system in accordance with the present invention.

FIG. 2 is home page display of a secured website.

FIG. 3 is an illustration of a window showing the teams or groups or communities to which a particular member belongs.

FIG. 4 is a window display for the prayer request tab.

FIG. 5 is a window display for making a prayer request.

FIG. 6 is an illustration of an email notification to a leader.

FIG. 7 is an illustration of an email notification to a member.

FIG. 8 is a window display for the calendar tab.

FIG. 9 is a window display for the directory tab.

FIG. 10 is an illustration of a window-in-window when the map button is selected.

FIG. 11 is a window display for the photo album tab.

### DESCRIPTION OF THE PREFERRED EMBODIMENTS

The preferred embodiment relates to an asynchronous, leader-facilitated, collaborative networked communication system in accordance with the present invention. The system is intended for use by a team or group or community where the members may not frequently see one another, the needs of the group or community generally are not determinable or possibly predictable by a leader, but rather emanate from the members of the community, and one of the purposes of the community is to provide self-support or encouragement. Therefore communication is generally member-initiated. A leader is selected to facilitate the communication process and to ensure that communications, which can be very personal and very private, are respectful and appropriate subject matter. The preferred embodiment is implemented in a charitable or faith-based environment.

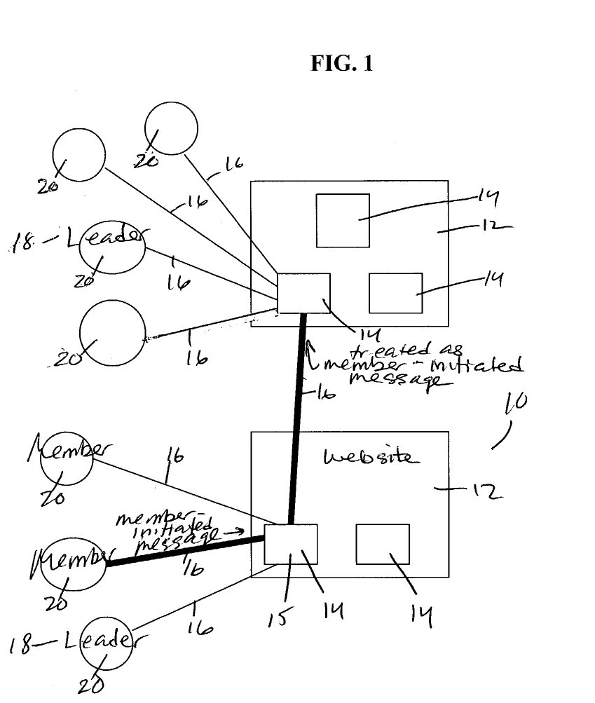

As shown in FIG. 1, the system 10 is comprised of a secure website 12 having at least one website location 14 and wherein a website location 15 is designated for use by the community, a member access 16 for each member to the community's website location, a community leader 18 to facilitate member use of the community's website location 15, and a member-initiated message (not shown) and a communication session (not shown). The website 12 is operatively connected to the Internet to receive and broadcast communications and only members have authorized access to it. Each member has a member access 16 to the website 12 by establishing a connection with the website 12 via the Internet using an Internet browser software program 20, and preferably a host that is thin-client/browser-based, and signing into the website using an identifying characteristic such as a password, answer to a question, or scan of a personal feature. Only members of registered teams or groups or communities have authorized access to the website 12, and only members of a team, group, or community have access to that term's, group's, and community's location.

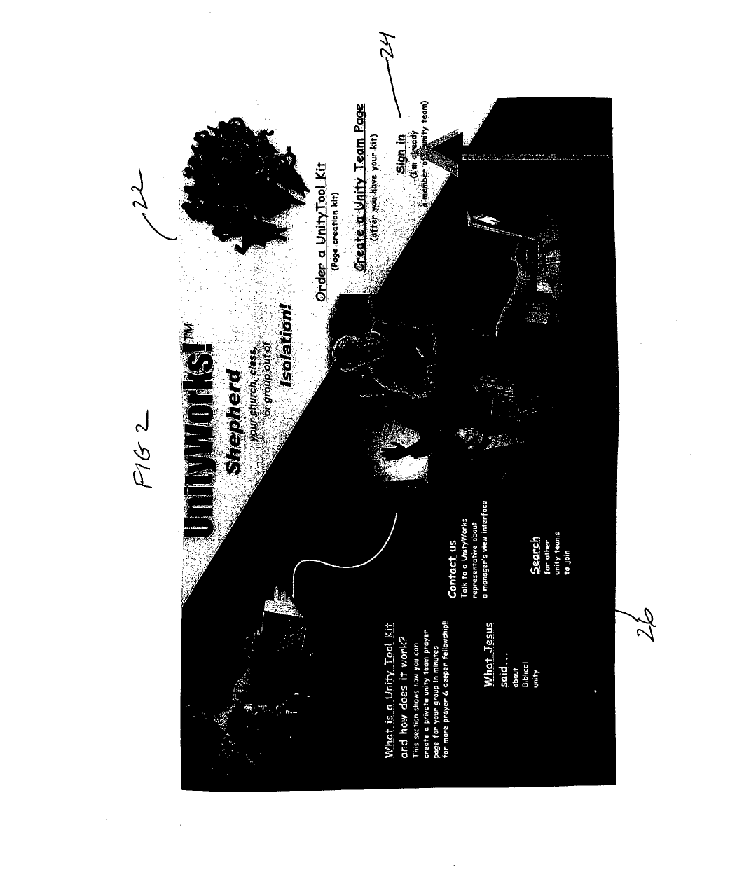

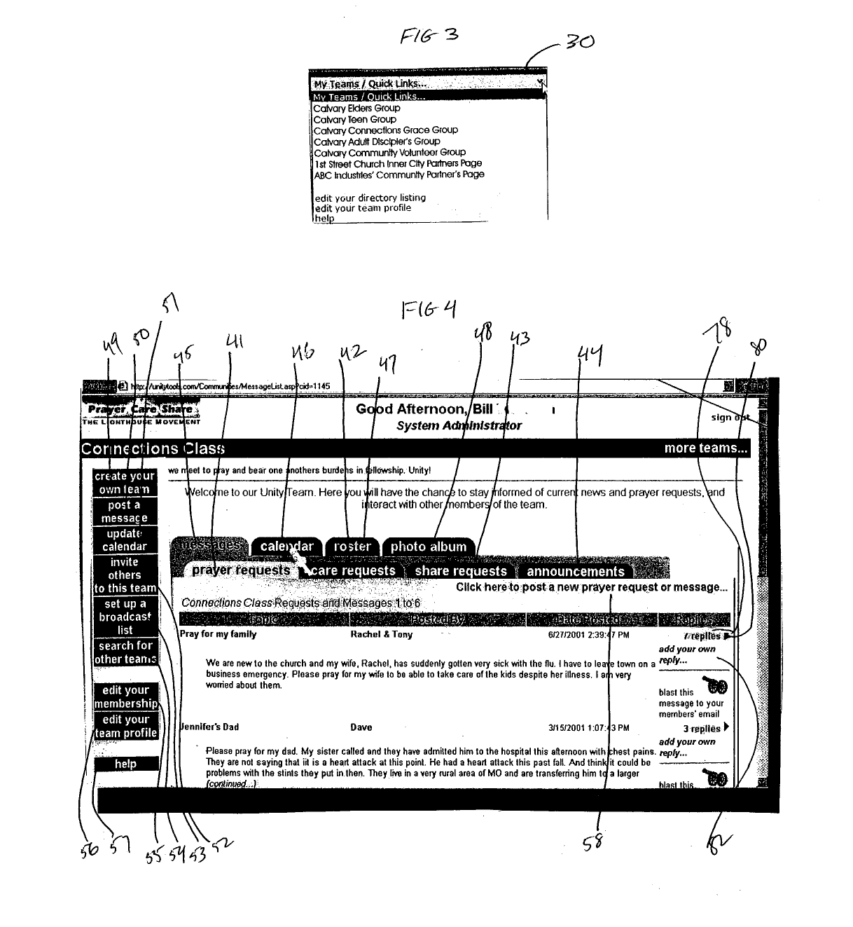

In operation, a member having authorized access to the website first connects via the Internet to the website's Internet home page 22, as shown in FIG. 2, and then signs in 24. The member is then presented with a table of names 30, as shown in FIG. 3, corresponding to the teams or groups or communities to which the member belongs. The member selects a name of a community to access the location of that community, and can only access a community for which access has been previously arranged, i.e., to which he or she belongs. Before signing in 24, a user is given an option to search or explore 26 for other teams, groups, or communities that might interest the member, based on a name or attribute. The result of the search is a list of communities that fit the search term along with a description of each team. The viewer may use this information to request membership, preferably via email, with a certain team or group or community, but the search option will not allow the viewer to enter the location of teams or groups or communities to which he or she does not belong.

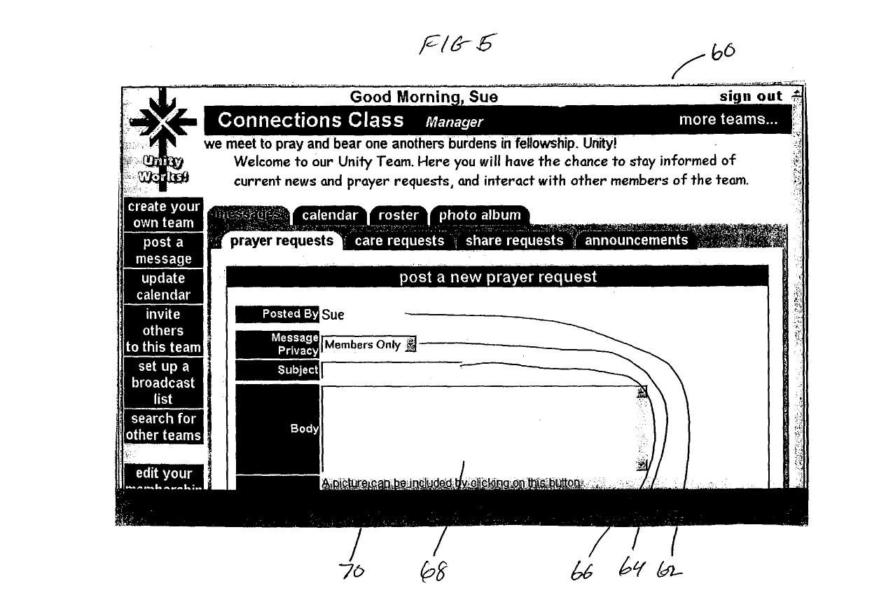

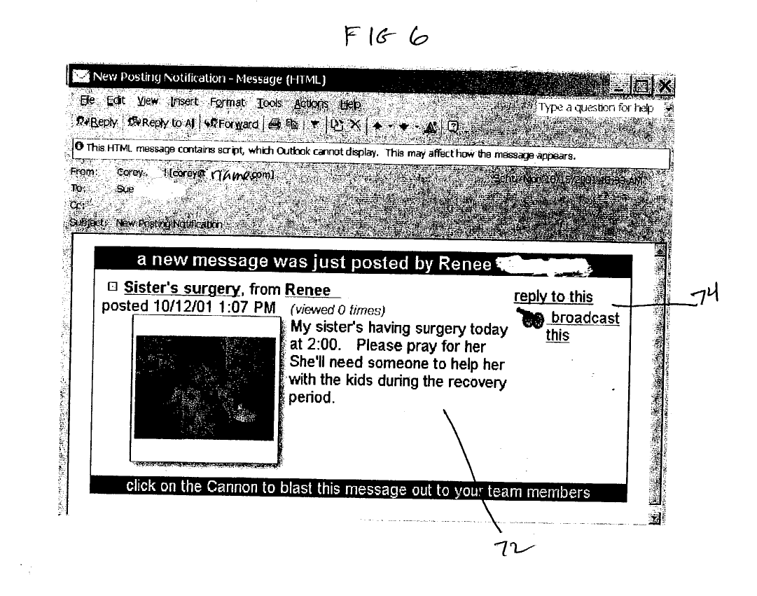

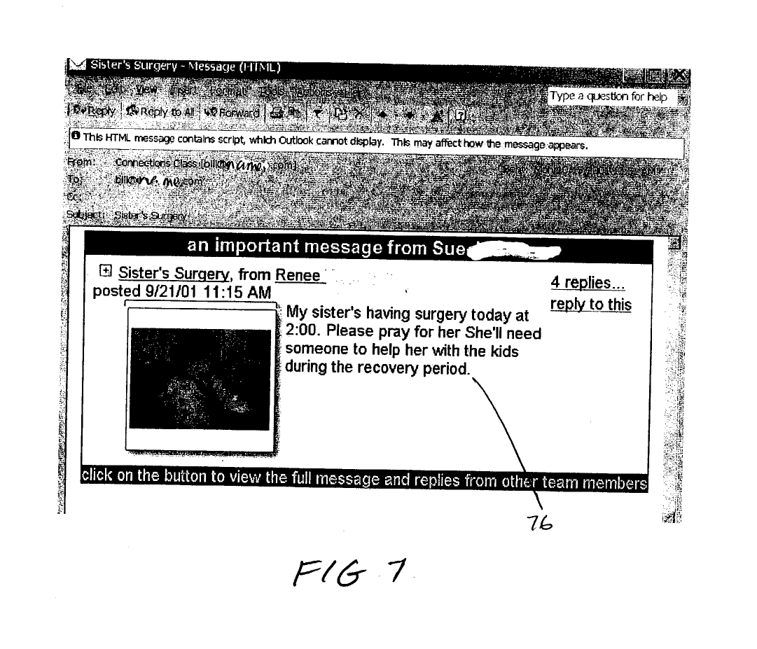

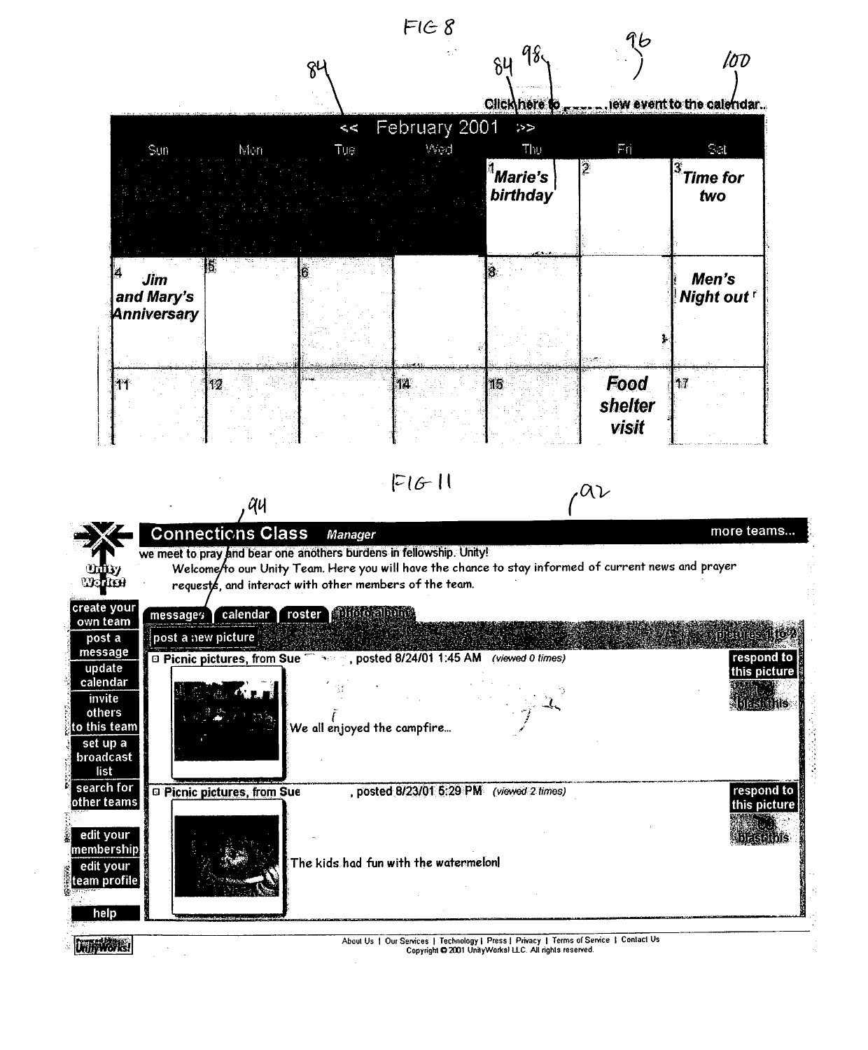

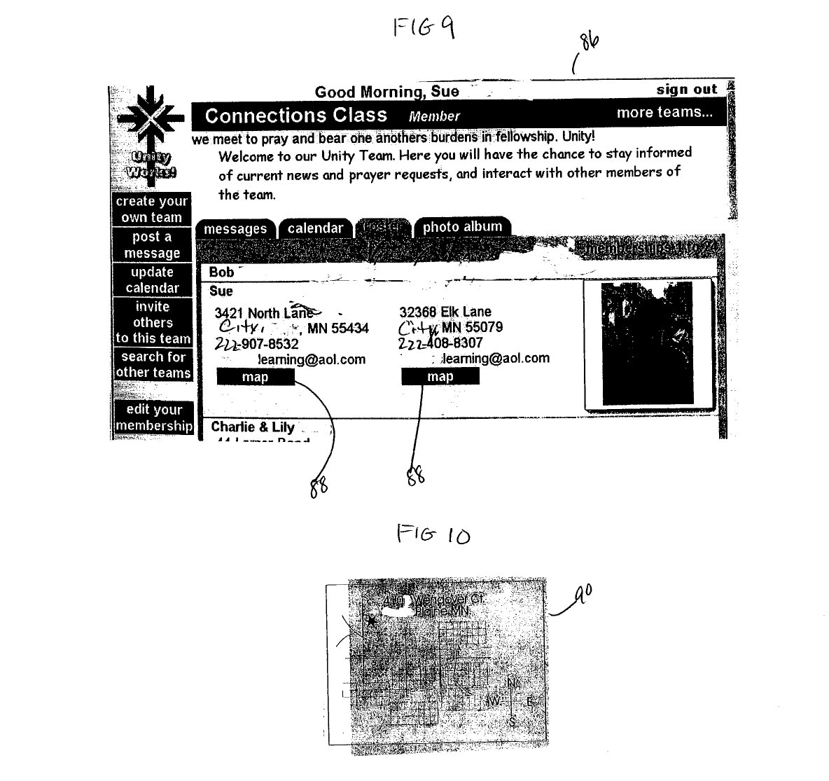

When a member successfully signs in, a community webpage 40 appears, as shown in FIG. 4. On this webpage are a series of tabs and buttons for selecting a task in which to engage. The preferred embodiment has eight tabs, a “prayer request” tab 41, a “care request” tab 42, a “share request” tab 43, and an “announcements” tab 44, a “messages” tab 45, a “calendar” tab 46, a “roster tab” 47, and a “photo album” tab 48. Prayer requests, care requests, share requests, and announcements are member-initiated messages. Buttons include a “create your own team” button 49, “post a message” button 50, “update calendar” button 51, “invite others to this team” button 52, “set up a broadcast list” button 53, “search for other teams” button 54, “edit your membership” button 55, “edit your team profile” button 56, and “help” button 55. The “create your own team” button 49 opens a tool to create a new location and register a new team on the website. The “invite others to this team” button 52 opens a tool for emailing invitations to join the team, which invitations include a hyperlink to the team's registration page.

To send a member-initiated message, the appropriate tab is first selected and a window appears displaying previously made requests and tools for making a new request of that kind. For example if a prayer request is selected, a window appears displaying previously made prayer requests and tools for prayer requests, as in FIG. 4. The “Click here to post a new prayer request or message” button 58 is selected and a new request window 60 opens for making the request, as shown in FIG. 5. The new request window indicates who the request is from 62 and has a “Message Privacy” box 64, a “Subject” box 66, a message “Body” box 68, and box for including a photograph 70. The “Message Privacy” box 64 allows the member to indicate the level of communication he or she wishes to have, the “Subject” box 66 can be used to entitle or otherwise banner the request, and the message “Body” box 68 is used to hold the prayer request. A message can be entered directly into the message “Body” box 68 or pasted there from an editor such as Microsoft Word™. A photograph is incorporated into a story by browsing for the photo and clicking on the photo to create a path from the photo to the request window. The prayer request is then posted to the community's website location via the member access for viewing only by the leader.

The leader is notified via an email 72 when the member-initiated message is posted on the community's website location. The email preferably has a hyperlink (not shown) to the community's website location so that he or she can quickly and conveniently view the request. Upon reviewing the request, the leader decides whether to retain on the community's website location at least a portion of the request to be viewed by the other members. This may include rejecting a request as inappropriate. The leader may also be given more extensive control over communications aspects of the request such as editing wording, fonts, formatting, and sentence and grammatical structure and such as cropping or touching up a photo. Generally the leader tries to exercise such control without changing the tenor of the request. When the leader has managers to assist him or her, leader control over any communications aspect is delegable to the at least on manager. In an alternative embodiment, only the leader can view a member initiated-message when it is posted and the leader will decide whether to allow at least a portion of the request to be viewed by a portion of the membership, and if so, by whom. Another option of the alternative embodiment allows the control over at least one communications aspect to be overridden and all members automatically notified via email when the member-initiated message is posted on the community's website location. In both embodiments, the leader selectively notifies selected additional members that the member-initiated message is viewable on the community's website location, which decision is implemented in the form of a “cannon blast” or broadcasting the message to a subset of members or, as a default, every member. The leader is the only one with “cannon blasting” capability until he or she delegates it to managers; the cannon icon 74 for “cannon blasting” appears only on the pages of those having the authority to use it. When the “cannon blast” button is selected, a menu (not shown) appears that allows the leader to select the subset of members or default to everyone. In the alternative embodiment, the notification opens the message for viewing by these selected other members and authorizes via the community's website location a communications session, although those skilled in the art are aware that other actions may instead or also be used to trigger these permissions. The process of notifying selected members is accomplished via email 76, as shown in FIG. 7, which, like the email to the leader, contains a hyperlink (not shown) to the community's website location.

In the preferred embodiment, all members can view all the member-initiated messages and reply messages. In the alternative embodiment, the communications session allows only the selected members, including the leader and the member making the request, to asynchronously collaborate by viewing the member-initiated message and all reply messages sent to the community's website location in response to the member-initiated message or another reply message thereto. Reply messages are sorted by communication session and chronologically listed underneath the respective member-initiated message. For example, by selecting the “prayer request” tab, the prayer request window opens and the member can view member-initiated messages. As shown in FIG. 4, the requests are listed in reverse chronological order for a plurality of concurrent, authorized communication sessions, and a banner 78 above each request gives the title, the names of those posting the request, the date the request was posted, and the number of replies. Clicking on an arrow 80 next to the number of replies displays the replies. A button 82 located next to the number of replies allows the member to add another reply message of his or her own. The above-described processes are similar for all the requests.

As in FIG. 1, with this system of member-initiated, leader-facilitated communication, chains of notification can be used to communicate between groups or teams or communities. For example, if a Sunday school teacher desires to discuss a teaching matter, he or she may send a member-initiated message to his or her team's website location. Upon reading the message, the education director or leader of that team may decide to notify other teachers and notify the ministry council, who may want to share the message with the congregation in general. Alternatively, the message may be more sensitive and the leader may notify only selected teachers and/or only the church board chair, who can then decide which board members to notify. In practical terms, the combinations of chains can be unlimited.

Managers can be selected to assist the leader or fulfill special roles. In the preferred embodiment, there is a prayer response manager to offer or provide prayerful responses to member-initiated messages, a scripture response manager to provide scripture or liturgical responses, a manager to provide comforting and supportive reply messages, a manager to provide devotional and reflective member-initiated messages, and a manager to communicate events of interest to members. The first three positions are very important to the purpose of the communication system, as they set examples for the community, and it is psychologically uplifting for persons in need to know or be aware that there are others who are hearing, sharing the burden of, and supportive of efforts to work through an emotional need. As those skilled in the art are aware, other manager roles may be created as needed.

Features to enhance the attractiveness of the communication system are a “messages” window, a calendar, a roster or directory, and a photo album. As shown in FIG. 8, if the calendar tab is selected, a calendar window 96 with a calendar 98 appears displaying notices of events and other announcements of interest to the community, and to which the member can add new notices and announcements by clicking on a “Click here to post a new event to the calendar” button 100 and then adding the information on the appropriate date. The calendar can move forward or backward by clicking on one of the arrows 84 on a banner at the top of the calendar on either side of the month. If the roster or directory tab is selected, a directory window 86 appears showing members' names, addresses, telephone numbers, and an available photo. A dynamic email address may also be included. Moreover, by clicking on a “map” button 88, a window-in-window 90 will appear, as shown in FIG. 10, providing a map to the members' home address or event location. The messages tab and the photo album tab, when clicked upon, cause a general message board or a repository of shared photographs to appear, respectively. For example, as shown in FIG. 4, by clicking on the “post a new picture” button 94 on the photo album window 92, a window (not shown) with photo album tools opens to capture a photograph. The window has a box to insert a title for the photo, a box to insert a description of the photo, and a browse button to capture the photo. Pictures must be in JPEG format and are automatically resized to fit the size of photo frame used in the photo album, and the tools automatically date the photo as of the posting date. Video streams, audio streams, and other multimedia as well as photos, or any combination thereof, may also be saved in the album or in any other feature where a photo is savable.

For a more detailed understanding of the overall structure, architecture and operation of a preferred embodiment, persons of skill in the art are referred to the commented source code that is included with the application, the disclosure of which is hereby incorporated by reference.

The attachments and source code accompanying this application are copyrighted and no license or other relinquishment of copyrights in these materials is granted by virtue of the inclusion of these materials in this patent application, other than a limited license to copy these materials as part of the patent application process or as part of and for the limited purpose of obtaining a copy of the wrapper history.

Although the preferred embodiment of the asynchronous, leader-facilitated, collaborative networked communication system has been described herein, it should be recognized that numerous changes and variations can be made and that the scope of the present invention is to be defined by the claims.

That which is claimed:

1. A method for member-initiated, asynchronous, collaborative communication among a predetermined community of members using the Internet, comprising:
(a) providing a secure website having at least one website location designated for use by members of the community;
(b) enabling a member to establish a browser-based connection with the website location and to post a member-initiated message on the website location;
(c) enabling at least one pre-designated leader to review the member-initiated message and notify selected members of the community that the member-initiated message is viewable on the website location, whereby a communication session with respect to the member-initiated message is initiated among the community of members via the website location.

2. The method of claim 1, wherein step (b) is accomplished via a thin-client Internet browser.

3. The method of claim 1, wherein step (c) includes a step of notifying the leader via email when the member-initiated message is posted on the website location, wherein the email contains a hyperlink to the website location.

4. The method of claim 1, wherein step (c) enables the leader to edit the member-initiated message as part of the review of the member-initiated message.

5. The method of claim 1, wherein the step of notifying selected members in step (c) is accomplished via email, and wherein the email contains a hyperlink to the community's website location.

6. The method of claim 1, wherein member-initiated messages include messages selected from the group of messages consisting of prayer requests, care requests, share requests, announcements, or any combination thereof.

7. The method of claim 1, wherein the communication session initiated in step (c) includes a plurality of replys message from other members, and wherein each reply message is chronologically listed below the respective member-initiated message.

8. A method for member-initiated, asynchronous, collaborative communication among a predetermined community of members using the Internet, comprising:
(a) providing a secure website having at least one website location, wherein the website is operatively connected to the Internet to receive and broadcast communications, and wherein a website location is designated for use by the community;
(b) designating at least one community leader;
(c) providing each member with a member access to the community's website location when the member establishes an operative Internet connection with the website and properly identifies his- or herself, wherein the member uses a host that is browser-based;
(d) posting a member-initiated message on the community's website location via a member access to the community's website location, wherein the member-initiated message is viewable only by the leader until the leader broadcasts a notification that the member-initiated message is viewable on the community's website location;
(e) enabling the leader to review the member-initiated message; and
(f) having the leader to selectively notify selected members that the member-initiated message is viewable on the community's website location, whereby the member-initiated message becomes viewable on the community's website location to the selectively notified members, and whereby a communication session with respect to the member-initiated message and including only the selectively notified members, member posting the member-initiated message, and the leader is authorized via the community's website location.

9. The method of claim 8, wherein step (e) includes determining whether at least a portion of the member-initiated message should be broadcast to at least a portion of the members.

10. The method of claim 9, wherein the leader is permitted to selectively edit the member-initiated message prior to step (f).

11. A computer program for executing a computer process, the computer program being storage medium readable by a computing system operating as a secure website having at least one website location, wherein the website is operatively connected to the Internet, and wherein a website location is designated for use by a predetermined community of members having a community leader, to receive and broadcast member-initiated, asynchronous, collaborative communications among the members, comprising the computer program implemented steps of:
(a) requesting a viewer of the website to provide at least one identifying characteristic to determine whether the viewer is authorized to access the website, wherein the viewer uses a host that is browser-based;
(b) if the viewer successfully accesses the website, requesting the viewer to choose between creating a member-initiated message option and a viewing previously posted messages option;
(c) if the viewer selects the creating a member-initiated message option,
presenting the viewer with a member-initiated message template webpage to create and post a member-initiated message on the community's website location, wherein the member-initiated message is reviewable by the leader;
enabling the leader to control at least one communications aspect with respect to the member-initiated message, including enabling the leader to notify selected members that the member-initiated message is viewable on the community's website location, whereby a communication session with respect to the member-initiated message is initiated via the community's website location; and
(d) if the viewer selects the viewing previously posted messages option,
presenting the viewer with all previously posted messages, and an option to post a reply message on the community's website location with a reply message template webpage.

12. The computer program of claim 11, wherein the viewer uses a host that is thin-client.

13. The computer program of claim 11, wherein step (b) includes the step of initially presenting a table of selectable names to the viewer, wherein each website location has a corresponding name listed in the table, and wherein the viewer has access only to each website location for which access has been previously arranged.

14. The computer program of claim 11, wherein step (c) includes the step of notifying the leader via email when a member-initiated message is posted to the website location, wherein the email contains a hyperlink to the website location.

15. The computer program of claim 11, wherein step (c) enables the leader to edit the member-initiated message as part of a review of the member-initiated message.

16. The computer program of claim 11, wherein step (c) enables one or more of a predetermined plurality of leaders to review the member-initiated message, at least one of the leaders being permitted to designate other leaders permitted to review the member-initiated message.

17. The computer program of claim 11, wherein the member-initiated message includes an option that causes step (c) to automatically notify at least two hierarchical levels of leaders when the member-initiated message is posted on the community's website location.

18. The computer program of claim 11, wherein the process of notifying selected members in step (c) is accomplished via email, and wherein the email contains a hyperlink to the website location.

19. The computer program of claim 11, wherein the community's website location permits a plurality of concurrent, authorized communication sessions, and wherein each reply message is sorted by communication session and chronologically listed underneath the respective member-initiated message.

20. The computer program of claim 11, wherein step (b) further includes an option of viewing member photos, viewing a member directory, and viewing a calendar of community related events.

21. The computer program of claim 11, wherein step (b) further includes an option to search for a community based on at least one community attribute.

22. The computer program of claim 11, wherein step (c) enables the leader to exclude access to the member-initiated message until a leader has reviewed the member-initiated message.

23. The computer program of claim 11, wherein step (c) enables the leader to edit the member-initiated message.

24. The computer program of claim 11, wherein enabling the leader to control at least one communications aspect in step (c) includes determining whether at least a portion of the message should be broadcast to at least a portion of the members.

25. A system for member-initiated, asynchronous, collaborative communication among a predetermined community of members using the Internet, comprising:
a secure website having at least one website location, wherein the website is operatively connected to the Internet to receive and broadcast communications, wherein a website location is designated for use by the community, and wherein only members have authorized access to the website;
a member access for each member to the community's website location, wherein each member access is established via an Internet connection using an Internet browser software program;
an interface for at least one predetermined community leader to facilitate member use of the community's website location;
a member-initiated message posted on the community's website location via a member access, wherein the member-initiated message is reviewable by the leader, and wherein the leader exercises control over at least one communications aspect with respect to the member-initiated message; and a communication session via the community's website location with respect to the member-initiated message.

26. The system of claim 25, wherein the interface includes a leader initiated process of notifying selected members that is accomplished via email, and wherein the email contains a hyperlink to the community's website location.

27. The system of claim 25, wherein each member access is thin-client.

28. The system of claim 25, wherein the website has a table of selectable names, wherein each website location has a corresponding name listed in the table, and wherein access to each website location is given only when access has been previously arranged.

29. The system of claim 25, wherein the interface notifies a leader via email when the member-initiated message is posted on the community's website location, and wherein the email contains a hyperlink to the community's website location.

30. The system of claim 25, wherein the interface permits a leader to edit the member-initiated message as part of reviewing the member-initiated message.

31. The system of claim 25, wherein the community's website location has a plurality of concurrent, authorized communication sessions, wherein each reply message is sorted by communication session and chronologically listed underneath the respective member-initiated message.

32. The system of claim 25, wherein the community's website location has a calendar on which members can add events and announcements and view previously added events and announcements.

33. The system of claim 25, wherein the community's website location has a directory listing information selected from the group of information consisting of member names, member addresses, member telephone numbers, maps to members homes, photos of members, and dynamic email addresses to email communications to members, or any combination thereof.

34. The system of claim 25, wherein the website presents the viewer with an option to search for a community based on at least one community attribute.

35. The system of claim 25 wherein the member-initiated message includes an electronic photo, an audio stream, a video stream, or any combination thereof.
